(19) United States
(12) Patent Application Publication
(10) Pub. No.: US 2006/0242870 A1
(43) Pub. Date: Nov. 2, 2006

(54) Flame assembly for fireplace

(75) Inventors: Alan R. Atemboski, Renton, WA (US); Kurt W.F. Rumens, Kirkland, WA (US); Dominique R. Pitman, Hayden, ID (US); Terrence M. Burke, Pollock Pines, CA (US)

Correspondence Address: PERKINS COIE LLP;PATENT-SEA, P.O. BOX 1247, SEATTLE, WA, 98111-1247, US

(73) Assignee: Travis Industries, Inc., Mukilteo, WA (US)

(21) Appl. No.: 11/350,645

(22) Filed: Feb. 8, 2006

Related U.S. Application Data
(60) Provisional application No. 60/651,528, filed on Feb. 8, 2005.

(51) Int. Cl. G09F 19/00

(52) U.S. Cl. 40/428

(57) ABSTRACT

An electric fireplace assembly is disclosed and discussed. An electric fireplace of an embodiment includes a housing, a screen assembly having a translucent picture or image, a light panel behind the screen assembly, a controller coupled to the light panel, an image plate behind the screen assembly, and a reflector assembly above the light panel and behind the screen assembly.

### TECHNICAL FIELD

The present application claims priority to U.S. Provisional Application No. 60/651,528 filed Feb. 8, 2005, which is incorporated herein by reference in its entirety.

### TECHNICAL FIELD

The present invention is directed to fireplaces, and more particularly to electric fireplaces having simulated fire.

### BACKGROUND

Conventional electric fireplaces provide simulated fires that often do not appear realistic. There is a need for an electric fireplace that provides a more realistic simulated fire.

### BRIEF DESCRIPTION OF THE DRAWINGS

FIG. 1 is a front elevation view of an electric fireplace system in accordance with an embodiment of the present invention.

FIG. 2 is an enlarged front elevation view of an electric fireplace system in accordance with an embodiment of the invention. An outer frame and glass cover have been removed for purposes of illustration.

FIG. 3 is a top isometric view of the screen assembly of FIG. 2 shown removed from the fireplace housing.

FIG. 4 is a front isometric view of the electric fireplace assembly of FIG. 2, with the screen assembly and control panel removed for purposes of illustration.

FIG. 5 is a top perspective view of the electric fireplace assembly of FIG. 4.

FIG. 6 is another front perspective view of the electric fireplace assembly of FIG. 4.

FIG. 7 it is another front perspective view of the electric fireplace assembly of FIG. 4.

FIG. 8 is a side elevation view of the electric fireplace assembly of FIG. 2 showing internal components visible through an open access door.

FIG. 9 is an enlarged side elevation view of the electric fireplace assembly of FIG. 8 showing that the internal components visible through the open access door.

FIG. 10 is an enlarged side elevation view showing the internal components of the electric fireplace of FIG. 9.

### DETAILED DESCRIPTION

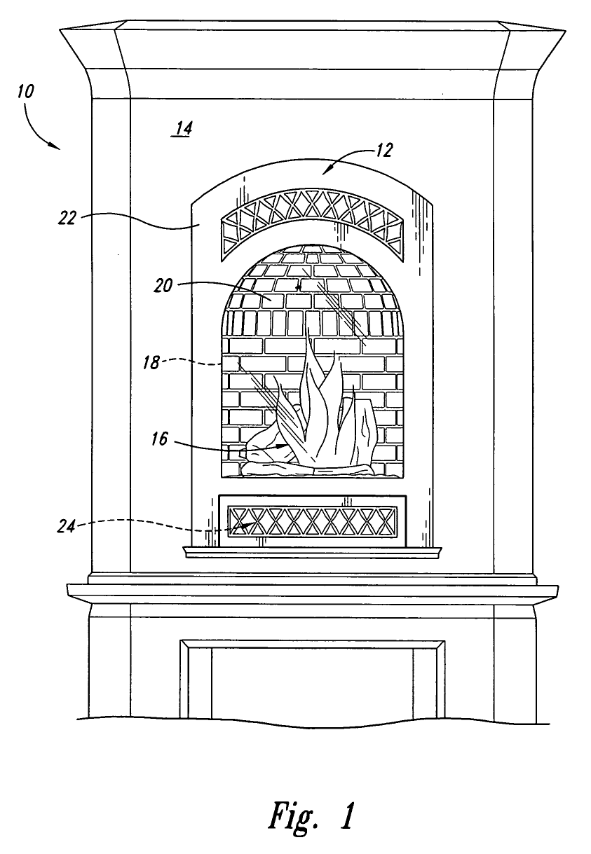

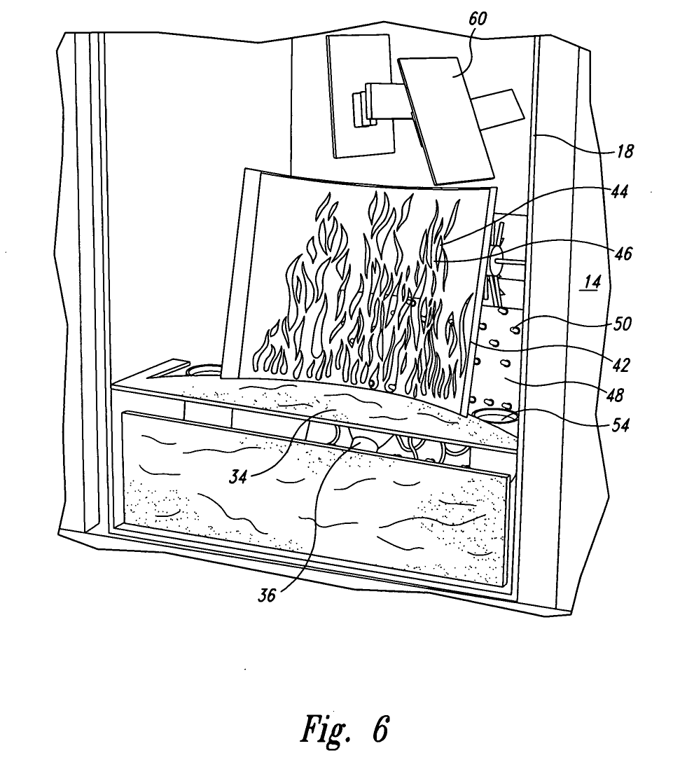

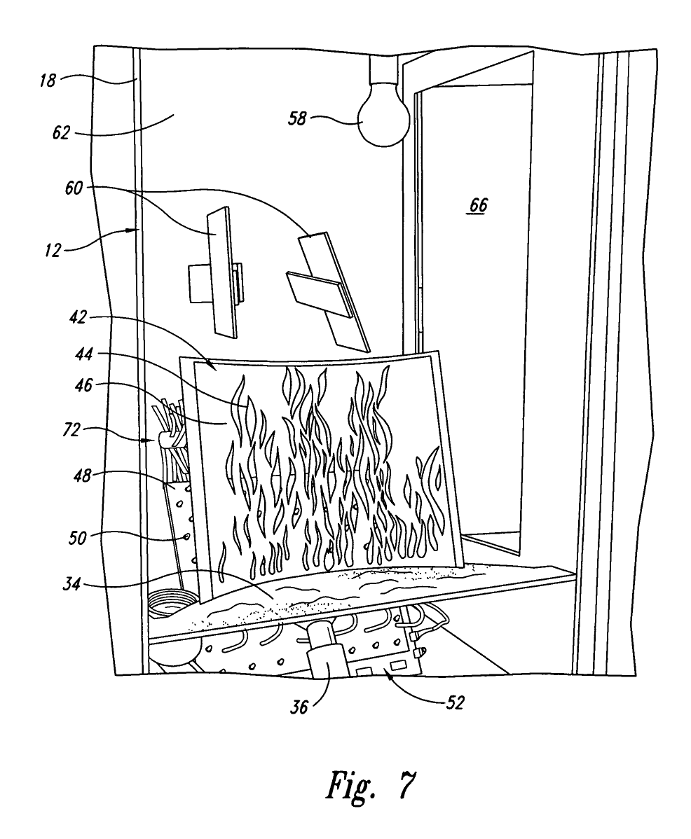

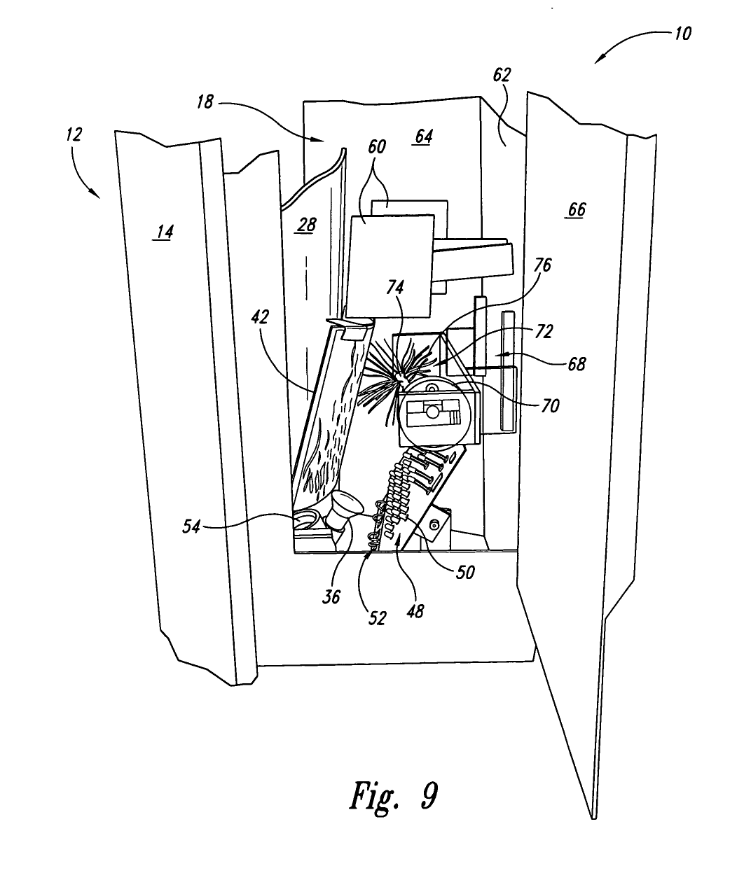

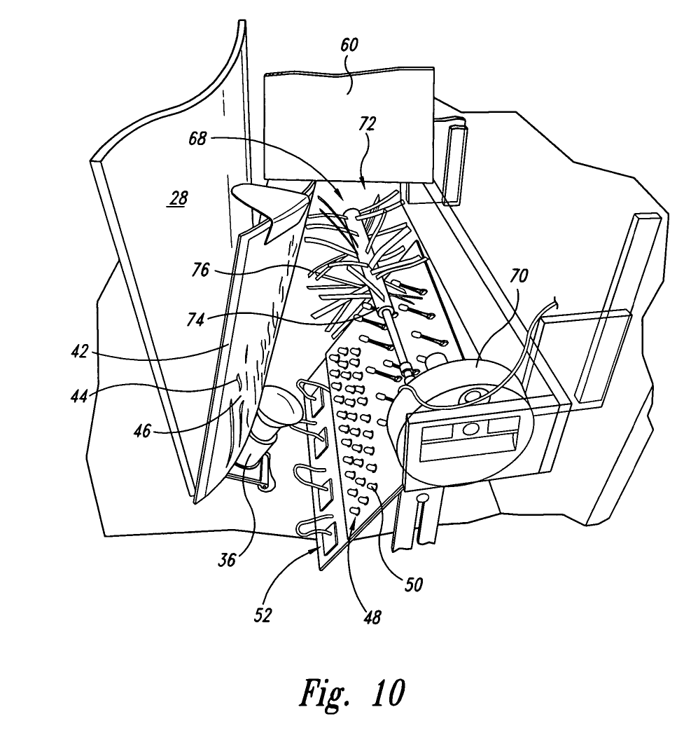

The present disclosure describes electric fireplace systems, including systems for providing images simulating a real wood-burning fire. Several specific details of the invention are set forth in the following description and in FIGS. 1-10 to provide a thorough understanding of certain embodiments of the invention. One skilled in the art, however, will understand that the present invention may have additional embodiments, and that other embodiments of the invention may be practiced without several of the specific features described below.

FIG. 1 is a front elevation view of an electric fireplace system 10 in accordance with an embodiment of the present invention. The electric fireplace system 10 includes an electric fireplace assembly 12 mounted in a cabinet 14. The electric fireplace assembly 12 is configured to provide static and active images 16 simulating a real wood-burning fire. The electric fireplace assembly 12 includes a housing 18 recessed within the cabinet 14, and a front glass cover 20 attached to the housing. The glass cover 20 in the illustrated embodiment can be transparent or tinted. In one embodiment, the glass cover 20 is a one-way mirror. The housing 18 and glass cover 20 are surrounded by a decorative outer frame 22 that attaches to the housing and to the cabinet 14. The fireplace assembly 12 also includes a controller 24 positioned in the bottom portion of the housing to control internal components (discussed in greater detail below) for providing the images 16 of the wood-burning fire.

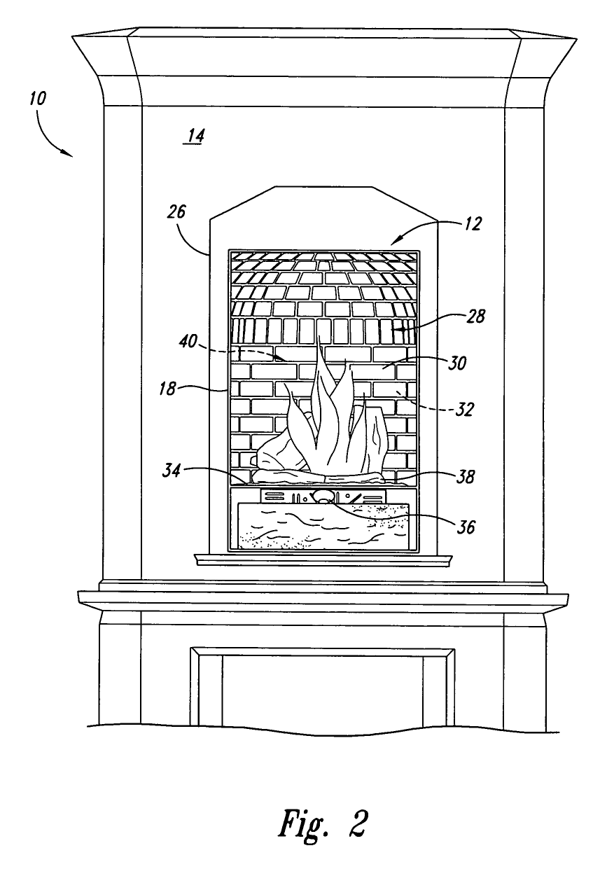

FIG. 2 is an enlarged front elevation view of the electric fireplace system 10 in accordance with an embodiment of the invention. The outer frame 22 and glass cover 20 shown in FIG. 1 have been removed for purposes of illustration to show some of the internal components within the housing 18, which is positioned within an aperture 26 in the cabinet 14. The fireplace assembly 12 includes a translucent screen assembly 28 that includes a picture 30 of a wood-burning fire burning in a brick fire chamber. The picture 30 of the illustrated embodiment is painted on a partially translucent material such that light can be projected through the photograph from the backside and be visible from the front side. In one embodiment, the picture 30 is mounted on a flexible panel 32 transparent material, such as plastic or Plexiglas. In another embodiment, the picture 30 or other image is printed directly onto flexible sheet of transparent plastic. In yet another embodiment, the picture 30 or other image can be attached to or printed other transparent or translucent layer, such as glass, sturdy photo paper or the like that will allow light to be projected through the picture from the backside to the front side.

In the illustrated embodiment, the panel 32 and the picture 30 are positioned within the housing 18 in a curved arrangement, such that the photograph is provided in a convex shape. While the picture 30 is a two-dimensional picture, the curved arrangement of the picture provides an appearance of a three dimensional wood-burning fire within the housing. In the illustrated embodiment, the screen assembly 28 is shaped in a partially cylindrical configuration, although the screen assembly in other embodiments can be formed with a partially spherical configuration or a combination of partially spherical and partially cylindrical shapes or other shapes.

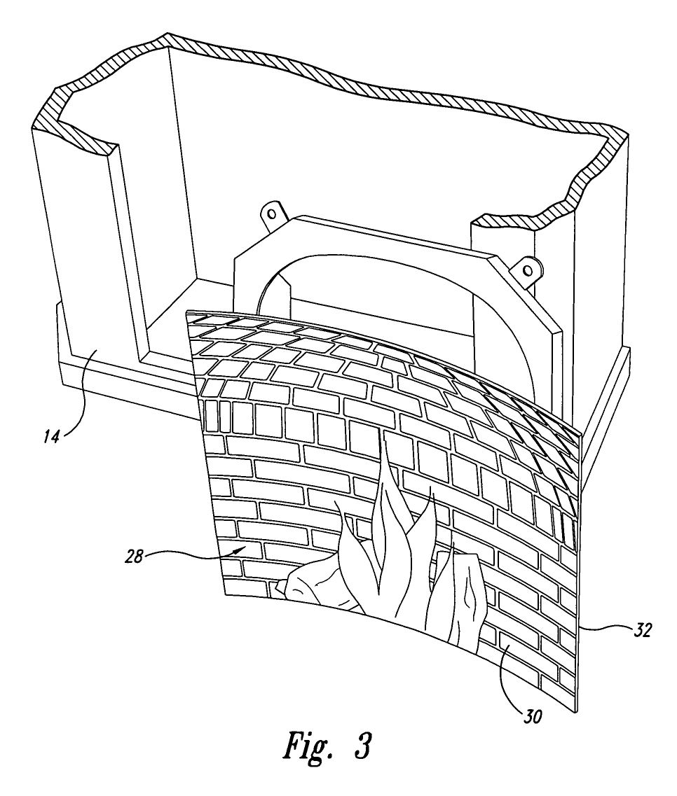

FIG. 3 is an isometric view of the screen assembly 28 of FIG. 2 shown removed from the fireplace housing 18. The flexible panel 32 of the illustrated embodiment is a flat sheet of Plexiglas to which the picture is attached or onto which an image can be printed. In another embodiment, the screen assembly 28 can include a panel (flexible or not) having relief portions integrally formed therein that provided three-dimensional projections within the panel. For example, the panel can have relief portions at least partially in the shape of a simulated log, flames, coals, bricks or other items that may be typically found in a wood-burning fireplace. The picture 30 can be applied to or printed on the panel to follow the relief portions, thereby providing three dimensional images of at least portions of a wood-burning fire in a fireplace.

The screen assembly 28 of the illustrated embodiment is positioned within the housing 18 adjacent to a simulated coal bed 34. In the simulated coal bed 34 includes a substantially horizontal plate having opaque portions and translucent portions through which light may be projected from below the plate. A light 36 is positioned in the housing generally below the coal bed 34 and aimed so a portion of the light shines upwardly through the coal bed to provide an image of burning coals. In the illustrated embodiment, the translucent portions of the coal bed 34 can include different colors that simulate the coal bed of a natural wood-burning fire. As an example, the coal bed 34 can be provided with translucent materials having one or more shades of red, orange, yellow or other colors (and combinations thereof) through which to light can project to provide the image of a burning coal bed. In one embodiment, the fireplace assembly 12 can have one or more colored lights below the coal bed to help provide the image of a burning coal bed.

The fireplace assembly 12 of the illustrated embodiment also includes one or more simulated logs 38 positioned on the simulated coal bed 34 and in front of the screen assembly 28. The simulated logs 38 are conventional simulated logs that provide a three dimensional item within the fireplace housing adjacent to the screen assembly to add to the three-dimensional appearance of the picture 30.

The screen assembly 28 of illustrated in positioned in the housing 18 in front of a projection system 40 that illuminates the picture 30 and the housing, and that can generate a variety of moving flame images onto the backside of the translucent screen assembly. Accordingly, the light and moving flame images can be seen through the picture 30. The projection system 40 is configured to provide multiple images of flames moving in different patterns on the screen assembly 28 to simulated flame patterns that may be seen in a wood-burning fire. This apparent random arrangement of flames projected through the screen assembly 28 adds to the realistic appearance of the wood-burning fire.

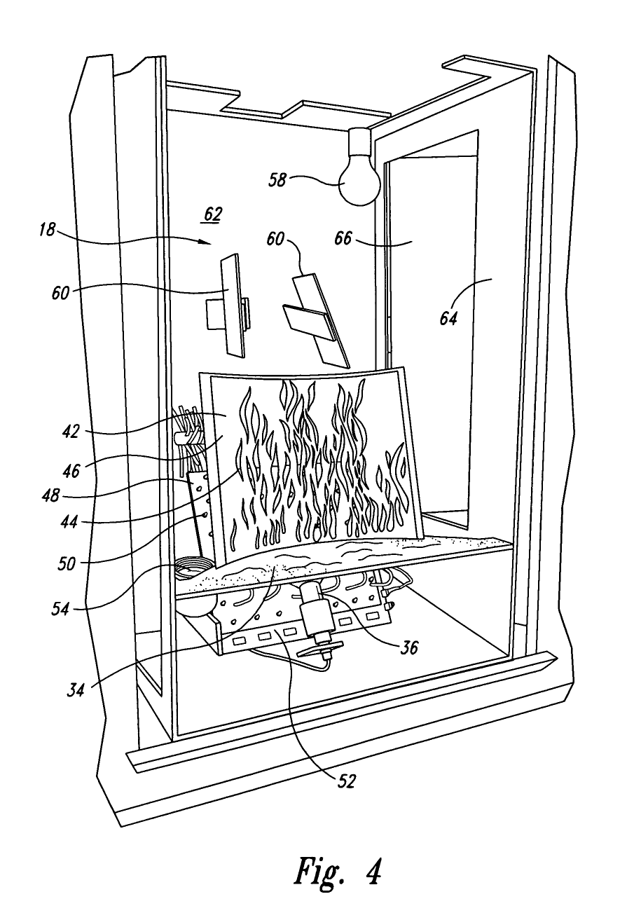

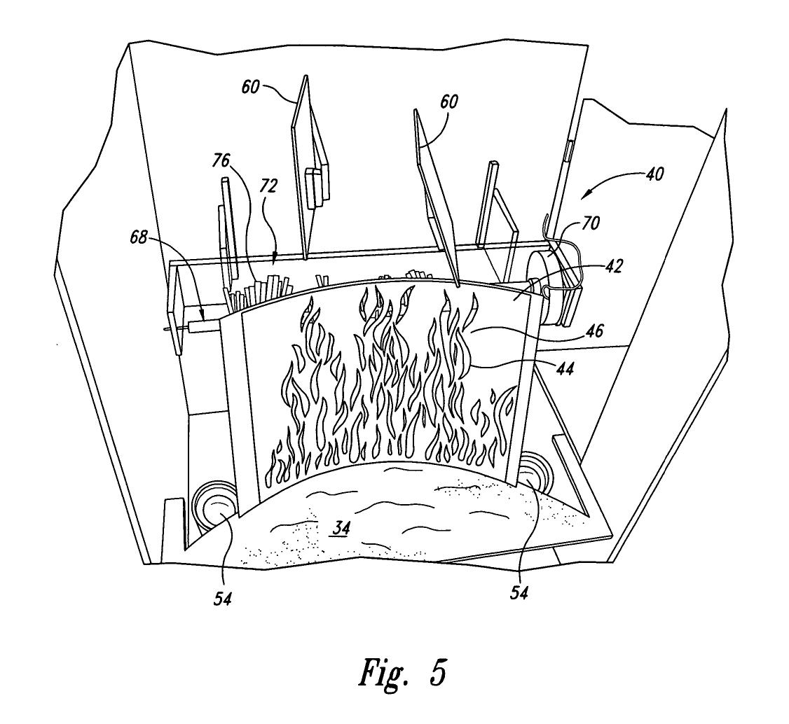

FIG. 4 is a front isometric view of the electric fireplace assembly 12 with the screen assembly 28 and a control panel removed to show the projection system 40 and other internal components within the fireplace housing 18. FIGS. 5-7 are additional views of the projection system 40 and the other internal components of the fireplace assembly 12. The fireplace assembly 12 includes an image plate 42 mounted adjacent to the back edge of the simulated coal bed 34 and positioned behind the screen assembly 28 (not shown). The image plate 42 is an arcuate shape member oriented to an angle relative to the screen assembly 28. Accordingly, the image plate 42 is oriented on an inclined plane (e.g., tipped slightly rearwardly toward the back of the housing 18) relative to the screen assembly 28. The image plate 42 includes a plurality of transparent or translucent flame portions 44 through which light can pass. The image plate 42 also includes opaque portions 46 surrounding the flame portions, such that light is allowed pass through the image plate and project onto the screen assembly 28 only through the flame portions 44.

The image plate 42 is positioned above and in a front of a light panel 48 that includes a plurality of lights 50, such as light emitting diodes (LEDs). The light panel 48 is connected to the controller that controls the pattern and timing that the lights 50 are turned on and off. The light panel 48 is positioned within the housing 18 at a rearwardly sloping angle greater than the rearwardly sloping angle of the image plate 42. When one or more of the lights 50 are turned on, the light is projected through the flame portions 44 of the image plate 42 onto the back of the screen assembly 28. The angle of the light panel 48 and the angle of the image plate 42 are such that the flame images projected from the image plate onto the screen assembly 28 are smaller and shorter toward the base of the image plate and on the bottom portion of the screen assembly. As the light moves upwardly and projects through upper portions of the image plate, the projected flames appear to grow and extend as they are projected further up the screen assembly. The lights on the light panel 48 can be activated in a selected pattern to provide a projected image shift laterally, thereby achieving the apparent side-to-side movement of the flames projected from the image plate 42 onto the screen assembly 28. The resulting visual image on the screen assembly simulates extended, growing and flickering flames extending upwardly from the simulated fire.

The light panel 48 and the controller 52 are configured and programmed to turn individual lights 50 on and off in a blended fashion to provide a smooth transitioning projection of different lights through the image plate on to the screen assembly in a way that simulates a random movement of actual flames. The light control system 52 is also configured to time the activation and pattern of the lights in a manner that minimizes a strobe light effect. The resulting smooth blended, apparently random pattern of activated lights provides a realistic image of flickering and dancing flames projected onto and through the screen assembly 28.

The fireplace assembly 12 also includes left and right lower lights 54 and a pair of upper lights 58. The lower lights 54 project upwardly past the simulated coal bed and are aimed to help provide a general illumination of the rear side of screen assembly 28. The upper lights 58 project downwardly and provide illumination from the top the housing onto the project or screen. The upper lights 58 can be independently controlled (i.e., turned on, off, or dimmed) relative to each other and relative to the lower lights 54 to help control the illumination across the screen assembly 28. The left and right lower lights 54 can also be independently controlled relative to each other to provide the selected lighting within the housing 18 to illuminate a screen assembly 28. The lower and upper lights 54 and 58 are configured and aimed to provide a general illumination through the screen assembly that simulated the glow within a wood burning fireplace when a fire is burning.

The fireplace assembly 12 of the illustrated embodiment also has a pair of shadow plates 60 mounted to a rear wall 62 of the housing 18. The shadow plates 60 each have a darkened non-reflective surface positioned in a selected orientation to disburse light and/or cast shadows with in the housing to help control in the light pattern projected onto the back of the screen assembly 28. The shadow plates 60 can be adjustable or can be in a fixed orientation within the housing 18.

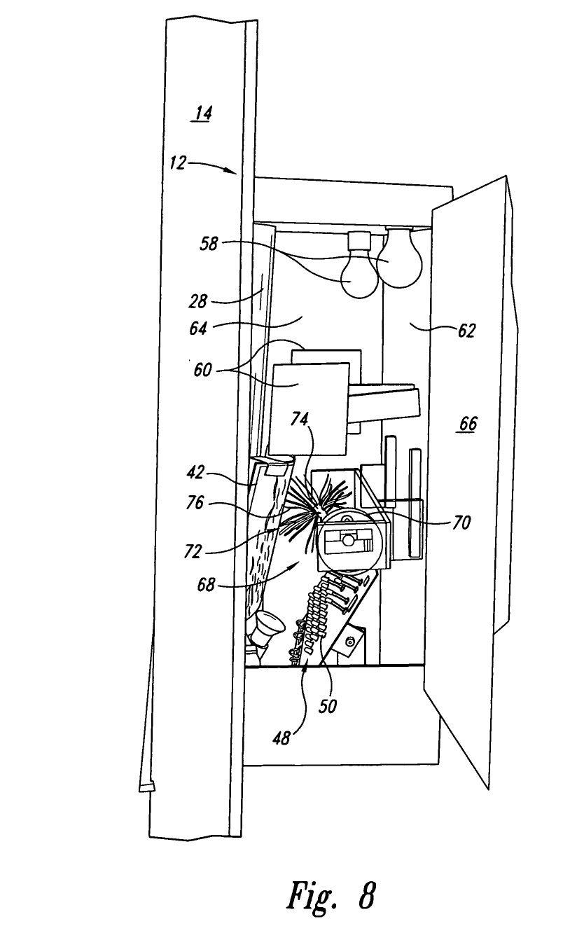

FIGS. 8-10 are side elevation views of the electric fireplace assembly 12 showing internal components positioned within the housing 18 behind the screen assembly 28. The housing 18 of the illustrated embodiment has the interior area defined by a pair of sidewalls 64 connected to the rear wall 62. One of the sidewalls 64 has an access door 66 therein that provides access to the interior components of the fireplace assembly within the housing. The fireplace assembly 12 of the illustrated embodiment also includes a reflector assembly 68 mounted to the rear wall 62 and positioned generally in front of and above the light panel 48. The reflector assembly 68 includes a drive motor 70 connected to a reflector wheel 72. The reflector wheel 72 includes a drive shaft 74 rotatably connected to the drive motor 70, and a plurality of reflector strips 76 connected to the drive shaft. The drive motor 70, when activated, rotates the drive shaft 74 such that the reflector strips 76 rotate above the light panel 48. In the illustrated embodiment, the reflector strips 76 are flexible strips of material with reflective surfaces such as strips of foil, Mylar, plastic, or other reflective material.

During operation of the fireplace assembly 12, the controller 52 turns on and off the lights 50 in a selected pattern. The reflector assembly 68 can be activated that the drive motor 70 causes the reflector wheel 72 to rotate the reflector strips 76 above the light panel 48. The lower light 36 generally below the coal bed is pointed upwardly into the interior area and is aimed at least partially at the reflector wheel 72. When the lower light 36 is turned on and the reflector wheel 72 is rotated, the reflector strips 76 reflect light from the lower light in a variety of angles through the image plate 42. This configuration results in moving light within the housing, thereby creating moving flame images projected onto the back of the screen assembly 28. In the illustrated embodiment, the reflector wheel is positioned generally a rearward and adjacent to the upper portion of the image plate.

The drive motor 70 is configured to rotate the reflector wheel 72 in a clockwise direction such that light reflected from the reflector strips 76 moves upwardly relative to the screen assembly 28 as the reflector wheel rotates. Accordingly, the light reflected from the reflector strips 76 through the image plates flame portions causes an image of an upwardly moving flame to be projected onto the lower portion of the screen assembly 28. As the reflector wheel 72 continues to rotate, the reflected light moves upwardly relative to the image plate 42 such that additional images of the flames from the upper portion of the image plate are projected onto the screen assembly. The rotation of the reflector strips 76 causes the light projecting through the image plate to vary in intensity, thereby providing an appearance of a variable or moving flame. The combination of the light from the reflector wheel 72 and the selected pattern of light from the light panel 48 results in the appearance of realistic looking flame images moving upwardly on the screen assembly to provide the illusion of upwardly flickering and dancing flames on the screen assembly 28. This image of the flickering and dancing flames is visible through the translucent screen assembly 28 to provide the appearance of flames from a natural wood-burning fire within the fireplace housing 18.

When the electric fireplace assembly 12 is activated, such that lights within the housing 18 are selectively turned on and off, the reflector wheel 72 is activated, the direct and reflected light moving within the housing 18 creates the illusion of dancing, growing, and flickering flames projected onto the screen assembly 28. The image of the moving dancing and flickering flames projects through the translucent screen assembly onto the picture 30 of the wood-burning fire, thereby resulting in a realistic image visible from the front side of the picture that simulates the look of a natural wood-burning fire. The electric fireplace of the illustrated embodiment can also include a heating element configured to generate heat from the unit when activated, thereby further simulating the results of a wood-burning fire.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. An electric fireplace assembly, comprising:
a housing;
a screen assembly having a translucent picture or image;
a light panel behind the screen assembly;
a controller coupled to the light panel;
an image plate behind the screen assembly; and
a reflector assembly above the light panel and behind the screen assembly.
